(19) United States
(12) Patent Application Publication
(10) Pub. No.: US 2008/0274444 A1
(43) Pub. Date: Nov. 6, 2008

(54) ELECTRONIC DATA EXCHANGE

(76) Inventor: Toufic Saliba, Toronto (CA)

Correspondence Address: REISING, ETHINGTON, BARNES, KISSELLE, P.C., P O BOX 4390, TROY, MI, 48099-4390, US

(21) Appl. No.: 11/744,537

(22) Filed: May 4, 2007

(51) Int. Cl. G09B 3/00

(52) U.S. Cl. 434/350

(57) ABSTRACT

In an aspect, the specification provides a system for exchange of data comprising a plurality of questioner workstations connectable to a network and a plurality of answerer workstations connectable to the network. The system also provides a data exchange engine connected to the questioner workstations and the answerer workstations via the network. The data exchange engine is configured to receive at least one question from at least one of the questioner workstations and to present the at least one question to at least one of the answerer workstations. The data exchange engine is also configured to maintain a compensation pool associated with the question. The data exchange engine is further configured to collect answers to the question and present the answers to the questioner. The data exchange engine is further configured to distribute at least a portion of the compensation pool to an answerer associated with at least one of the answerer workstations. The data exchange engine is further configured to receive a quality rating for each of the answers. The compensation pool is distributed to the answerer based on the answerer according to the ranking quality.

### FIELD

The present invention relates generally to computer networking and more particularly relates to an electronic data exchange.

### BACKGROUND

Computer networking, and specifically the Internet, has caused a seismic shift in how information, knowledge and other types of data are archived, stored and retrieved. Such networking also facilitates active dialogue between different parties as to the accuracy, development and presentation of such data. Search engines such as Google™ do provide powerful tools for searching existing data on the Internet. However, there is much room for advancement in how parties exchange data using computer networks.

### SUMMARY

The present specification, in one aspect, provides a system that provides programming interface for various natural language artificial intelligence (“AI”) software agents to compete between each other and humans in providing information to their users and questioners, and having questioners rate answerers based on how satisfied they are with the solution to the request provided. The request can be in any digital format and include the capability to attach, relate and correlate files of any type to the request and response.

The system can be available through any interactive channel of communication including phone and Internet to provide verbal interaction between human and computers and amongst each other by opening live discussions in the purpose of providing clarification to the provider from the requester, which in many cases can be a combination of computers and human competing for the best solution that can satisfy the requester. The system's general user interface provides any questioner with the capability to request any type of information and have human and/or AI processes compete between each other to provide the best results, whether it is an answer, a solution an opinion or any type of informational response to the request. In other words, an answer can be prepopulated in the system that anticipates a particular question. For example, a solution “y” for question “x”, can be put in the system so that solution “y” will immediately display to the requester as soon as question “x” is posed.

The system can utilize both monetary award and rating in some cases any requester and provider. The monetary awards are possible at each request and can be provided to the top sum of ratings based on various periods.

In an aspect, the specification provides a system for exchange of data comprising a plurality of questioner workstations connectable to a network and a plurality of answerer workstations connectable to the network. The system also provides a data exchange engine connected to the questioner workstations and the answerer workstations via the network. The data exchange engine is configured to receive at least one question from at least one of the questioner workstations and to present the at least one question to at least one of the answerer workstations. The data exchange engine is also configured to maintain a compensation pool associated with the question. The data exchange engine is further configured to collect answers to the question and present the answers to the questioner. The data exchange engine is further configured to distribute at least a portion of the compensation pool to an answerer associated with at least one of the answerer workstations. The data exchange engine is further configured to receive a quality rating for each of the answers. The compensation pool can be distributed to the answerer based on the answerer according to the ranking quality.

The Compensation can be monetary, and can be accredited by points that can add to the credibility of the compensated.

The compensation pool can be provided by a questioner associated with the one of the questioner workstations that provided the at least one question.

The compensation pool can be provided by a sponsor.

The quality rating can include receiving an indication from the questioner as to which of the answers is the best answer. A portion of the compensation pool can be distributed to the questioner upon completion of the quality ratings for each of the answers.

The quality rating can be provided by the answerers as well as the questioner and anyone who logs in to the system.

The quality rating can be provided by the answerers, particularly if the questioner does not provide the quality rating. For example, the average quality rating of all answerers will determine the best answer only if the questioner does not provide the quality rating.

The system can further comprise a plurality of enhancer workstations connected to the engine via the network. The enhancer workstations are configured to present either the questions or the answers and to receive data representing an improvement to the questions or the answers.

The workstations can be comprised of one or more of a computer, a wireless personal digital assistant, a cellular telephone, a telephone, a facsimile machine or any hardware/network tool that can accommodate this concept.

Another aspect of the specification provides a computer-based method of exchanging data comprising receiving a question from a questioner workstation at an data exchange engine; defining at the data exchange engine a compensation pool for the question; presenting the question to at least one answerer workstation operated by answerers; receiving responses to the question from the answers; distributing the compensation pool amongst the answerers and the questioners based on a rating for at least one of the answers. While the foregoing contemplates a compensation pool, it is to be understood that the amount of the compensation pool can be set to zero.

The rating can be received from the questioner. The rating can indicate the subjective view of the questioner as to which of the answers was the best answer. A portion of the compensation pool can be distributed to the answerer having provided the best answer.

The rating can be received from a plurality of the answerers. It can be desired to have the rating received from the plurality of the answers if the questioner declines to provide the rating.

The compensation pool can be provided by the questioner. The compensation pool can be provided by a sponsor.

A portion of the compensation pool can be distributed to the questioner upon completion of the quality ratings for each of the answers.

The method can further comprise the step of receiving enhancement data from one of a plurality of enhancer workstations connected to the engine directly or through a programming interface. The enhancement data can represent an improvement to the questions or the answers, either electronically or manually, depending on the preference of the enhancer.

The workstations can be comprised of one or more of a computer, a wireless personal digital assistant, a cellular telephone, a telephone, a facsimile machine or any device that can communicate with the system.

Another aspect of the specification provides a data exchange engine in accordance with the teachings herein. Another aspect of the specification provides a computer readable media containing programming instructions that are executable on various computing devices in accordance with the teachings herein.

### BRIEF DESCRIPTION OF THE DRAWINGS

FIG. 1 shows a system for exchange of data in accordance with an embodiment.

FIG. 2 shows a flowchart depicting a method for exchange of data in accordance with another embodiment.

FIG. 3 shows a system for exchange of data in accordance with another embodiment.

### DETAILED DESCRIPTION OF THE EMBODIMENTS

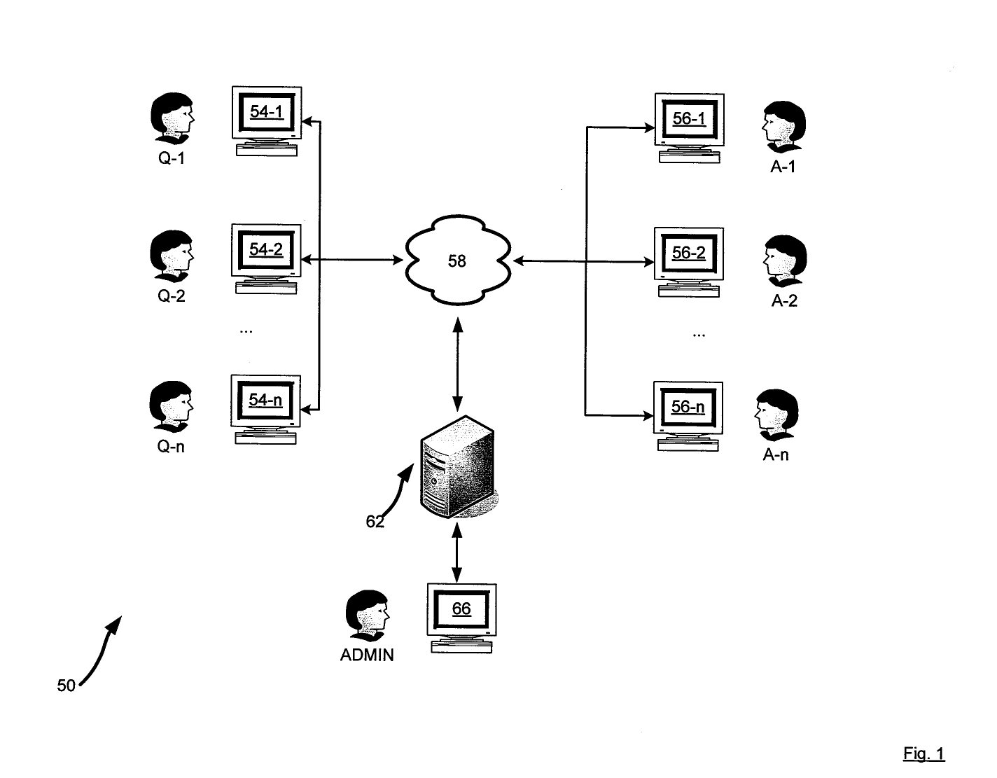

Referring now to FIG. 1, a system for exchange of data is indicated generally at 50. System 50 comprises a plurality of questioner's workstations 54-1, 54-2 . . . 54-n (generically referred to herein as “workstation 54” and collectively as “workstations 54”) all of which are connected to a data exchange engine 58 via any suitable network 62. System 50 also includes a plurality of answer's workstations 56 which are also connected to data exchange engine 58 via network 62.

Each workstation 54, 56 is typically a computing device such as a personal computer having a keyboard and mouse (or other input devices), a monitor (or other output device) and a desktop-module connecting the keyboard, mouse and monitor and housing one or more central processing units, volatile memory (i.e. random access memory), persistent memory (i.e. hard disk devices) and network interfaces to allow the workstation 54, 56 to communicate over network 58. However, it is to be understood that workstation 54, 56 can be any type of electronic device, such as a personal digital assistant, telephone, cellular telephone, facsimile, laptop computer, email paging device etc., that can be used to interact with engine 58, via a respective type of digital data exchange such as text, voice image etc.

Each workstation 54 is operated by a questioner Q. As will be explained further below, each questioner Q is interested in obtaining an answer to a question and will use their respective workstation 54 in order to interact with engine 58 in an attempt to answer that question. Questioners Q can be any individual in any location and need not be aware of each other.

Likewise, each workstation 56 is operated by an answerer A. As will be explained further below, each answerer A can be given an opportunity to answer to a question that is posed by a questioner Q. Again, answerers A can be any individual in any location and need not be aware of each other.

Typically, all questioners Q and answerers A will have unique user-id's, with appropriate authentication associated therewith, that are maintained on engine 66 so that each questioner Q and answerer A can be identified.

Data exchange engine 58 is a server, a mainframe, or other type of computing environment that is configured to, amongst other things, receive questions from workstations 54, present those questions to workstations 56, receive answers provided from workstations 56, and present those answers to the originating workstations 54. For example, data exchange engine 58 can be a Sun Fire V480 running a UNIX operating system, from Sun Microsystems, Inc. of Palo Alto Calif., and having four central processing units each operating at about 900 megahertz and having about sixteen gigabytes of random access memory. However, it is to be emphasized that this particular server is merely exemplary, a vast array of other types of computing environments for data exchange engine 58 are contemplated. An administrator terminal 66 is also connected to engine 58 and operable by an administrator ADMIN in order to administer and otherwise maintain engine 58. Terminal 66 can be based on the same types of hardware infrastructures as used for workstations 54.

Engine 58 is generally operable to facilitate interaction between workstations 54 and 58, according to the functionality of such workstations. Thus, interaction can be via data (e.g. web-browsing, email, text messaging, chat, facsimile) or via voice (e.g. live human interaction with administrator ADMIN, voice messaging, speech-to-text recognition, and text-to-voice performed at engine 58).

In a present embodiment, network 62 is any type of network, or combinations of networks, that is complementary to each workstation 54, 56 and to engine 58 in order to facilitate communications therebetween. An exemplary and typical network would be the Internet, but other types of networks, and/or combinations of networks are contemplated.

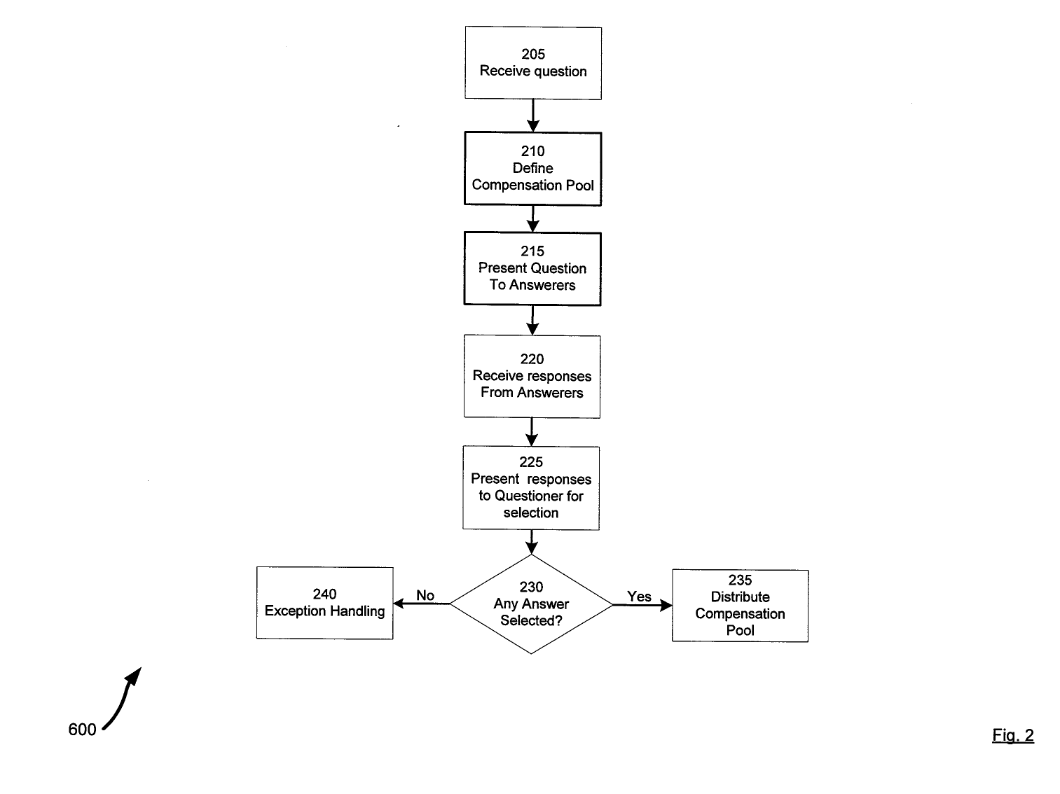

Referring now to FIG. 2, a method, depicted in the form of flow-chart, for data exchange is indicated generally at 200. Method 200 can be performed using system 50 and an understanding of method 200 will assist in further understanding of system 50, and vice versa. Accordingly, method 200 will be explained in relation to its performance using system 50. However, it should be understood that variations to system 50 and/or method 200 are contemplated.

Beginning first at step 205, a question is received. Step 205 can be performed by any questioner Q using their respective terminal 54 to enter a question, and to submit that question via network 58 to engine 62.

In a present embodiment, terminal 54 is configured to execute a web-browser and access a web-page hosted by engine 62 in order to provide a user interface for questioner Q to enter a question. It is presently preferred that engine 62 be configured to implement an artificial intelligence natural language engine (“NLE”) in order to permit questioner Q to enter their question in natural language form, however in other embodiments a non-natural language form is contemplated (e.g. keyword entry). As a highly simplified example, if questioner Q wanted to know the birth-date of Richard Nixon, questioner Q could simply enter “What is Richard Nixon's birthday?” It will become apparent however, that there is no limit or restriction on the type or complexity of question that that questioner Q can enter. The question posed by questioner Q is thus entered into its respective terminal Q and received at engine 62 where the question is stored.

Next, at step 210, a compensation pool is defined. The compensation pool is defined, in a present embodiment, by engine 62. The compensation pool is defined, in a present embodiment, in order to a) create an incentive for one or more answerers A to submit answer the question posed at step; b) create an incentive for the original questioner Q to select a “best” answer and, optionally, c) compensate an operator of engine 62.

The compensation pool can, in its simplest form, be financial in nature and thus represent a certain amount of funds in a given currency. However, the pool can also be “in-kind”, and include non-financial incentives such as coupons, vouchers, redeemable points and the like.

The compensation pool can originate from any source. In one embodiment, the compensation pool is provided by the questioner Q that submitted the question at step 205. Such a questioner Q can, using a credit card or other means of funds transfer, cause funds to be submitted to engine 62 where it is stored in an account that is associated both with that questioner Q and the question submitted at step 205.

In another embodiment, the compensation pool can be provided by a third party. Such a third party may wish to provoke dialogue and/or discussion between questioners Q and answerers A about a certain topic, and may therefore wish to sponsor that topic and offer to establish a compensation pool relative to that topic. For example, assume the third party is the US Government's Environmental Protection Agency (“EPA”) which wishes to provoke a dialogue about energy saving techniques. In this case the EPA may decide to provide the compensation pool at step 210 provided that a question relative to energy saving techniques is actually presented at step 205. In this example, it can be desired to also allow a representative from the EPA to connect to engine 62 in order to vet questions submitted at 205 and to select certain questions for which the EPA would intend to provide the compensation pool defined at step 210. As another example, assume the third party is an automobile manufacturer attempting to market a new car model. In this case, the manufacturer may decide to provide the compensation pool at step 210 provided that the question is relative to the new car model and will provoke dialogue among questioners Q and answerers A that may encourage the questioner Q to actually purchase the new car model.

Other means for establishing the compensation pool at step 210 will now occur to those skilled in the art.

Next, at step 215, the question received at step 205 is presented to answerers A. Step 215 can be achieved in a variety of ways. For example, the question can simply be pushed to every answerer A (e.g. via email), or the question can simply be posted on a web-page hosted by engine 62 so that each answerer A could, at his/her own leisure, browse the various questions that have been posted by questioners Q. Likewise, various answerers A may have profiles stored on engine 62 that indicate areas of expertise and skill so that certain types of questions are directed only to answerers A having a profile that corresponds to a particular type of question. As another example, questioners Q could be given the option of selecting which answerers A should receive the questions.

Next, at step 220, responses from answerers A are received. In system 50, those answerers A wishing to respond to the question received at step 205 can use their respective workstations 56 to submit their responses to the question received at step 205 via network 58 to engine 62.

At step 225, the responses received at step 225 are presented to the questioner Q who submitted the question at step 205. Step 225 can be performed by engine 62 either “pushing” those responses by, for example, email to the submitting questioner Q, or by posting the responses on a web-page hosted by engine 62 so that the questioner Q can use a web-browser to view those responses.

Also as part of step 225, questioner Q is given an opportunity to select one of the answers provided at step 220. The questioner Q is encouraged to select, on a basis subjective to that questioner, the “best” answer. Thus, at step 230, a determination is made as to whether an answer has been selected. If an answer has been selected, then method 200 advances to step 235 at which point the compensation pool established at step 210 is distributed. If no answer has been selected, then method 200 advances to step 240 for exception handling. Further details about steps 235 and 240 will be provided below.

It should be noted that, in general, the sequence of steps shown in FIG. 2 is not particularly limiting. Indeed, other sequences are contemplated and one/or more of those steps can be performed in parallel. For example, it is not necessary that all responses be gathered at step 220 before those responses can be presented at step 225—indeed, as each response is received it can be presented to the questioner at step 225. Thus, it should also be noted that the point at which it is determined at step 230 that “no”, an answer has not been selected can be configured within engine 62, perhaps by administrator ADMIN. As a presently contemplated configuration, if no answer has been selected (or indeed, no answer even provided by an answerer A at all at step 220), then after a two-week period from the date that the question was received at step 205, then a “no” determination will be made at step 230 and method 200 will advance to step 240 for exception handling. However, the two-week period is not fixed, and can be set to any period as desired by, for example, administrator ADMIN. The period can be based on, for example, statistical studies which indicate an optimal or otherwise desired user-experience. Likewise, other configurations can incorporated into engine 62 in order to make the determination at step 230 that “no” answer has been selected and to advance method 200 from step 230 to step 240.

In contrast, however, if the questioner Q that submitted the question at step 205 actually does select an answer, then method 200 will advance from step 230 to step 235.

As previously mentioned, at step 235, the compensation pool at step 210 is distributed. Recall that, in the present embodiment, the compensation pool was defined in order to a) create an incentive for one or more answerers A to submit answer the question posed at step; b) create an incentive for the original questioner Q to select a “best” answer and, optionally, c) compensate an operator of engine 62. In order to satisfy this definition, the compensation pool will be divided amongst a) the answerer A that submitted the “best” answer; b) the original questioner Q and, if selected, c) the operator of engine 62. The sizes of the portions which are given to each party are selected to create and/or maximize an incentive for exchange of data using system 50.

Where the compensation pool was originally submitted by questioner Q, then a presently preferred, but purely exemplary, apportionment includes providing a) 80% of the compensation pool to the answerer A that submitted that best answer b) 15% of the compensation and c) 5% of the compensation pool the operator of engine 62. Note however, that the compensation to the operator of engine 62 can be omitted altogether—the operator of engine 62 may simply charge a subscription, or use advertising to questioners Q and answerers A as a means to generate revenue. Other apportionments are contemplated—for example, the answers may be ranked and apportionments of the compensation pool provided to each answerer based on ranking. While the apportionment of compensation to questioner Q can also be set to zero, note that the provision of some portion of the compensation pool to questioner Q is intended to urge questioner Q to actually make a selection at step 225 and thereby avoid causing method 200 to proceed to step 240. Other apportionments will now occur to those skilled in the art. Indeed, system 50 can be modified so that apportionments are actually negotiated for each question as part of a modified version of method 200.

In the event that method 200 proceeds to step 240, then various exception handling procedures can be invoked, and such procedures can vary depending on the events that occurred prior to step 240.

For example, in the event that no responses were received from answerers A, then the exception handling at step 240 can provide for a) recommencing steps 215-230 and thereby resetting the period before which step 230 will make a “no” determination and advance method 200 to step 240; b) allowing the compensation pool to be increased in order to create additional incentive for answers to respond; or c) terminating method 200 altogether without attempting to seek further answers, in which case the compensation pool can be returned to its contributor or “banked” to be used for a future question and invocation of method 200.

As another example, in the event that responses were received from answerers A at step 220, but the questioner Q has simply declined to select a “best” answer then the exception handling at step 240 can provide for a) permitting all answerers A to rank the answers and thereby allow the answerers A to select the “best” answer, and thereby allowing the compensation pool to be distributed; b) asking the questioner Q to indicate why there is no “best” answer and/or to clarify the question to provoke additional answers, or clarifications to the answers so that the questioner Q will be inclined to select a “best” answer.

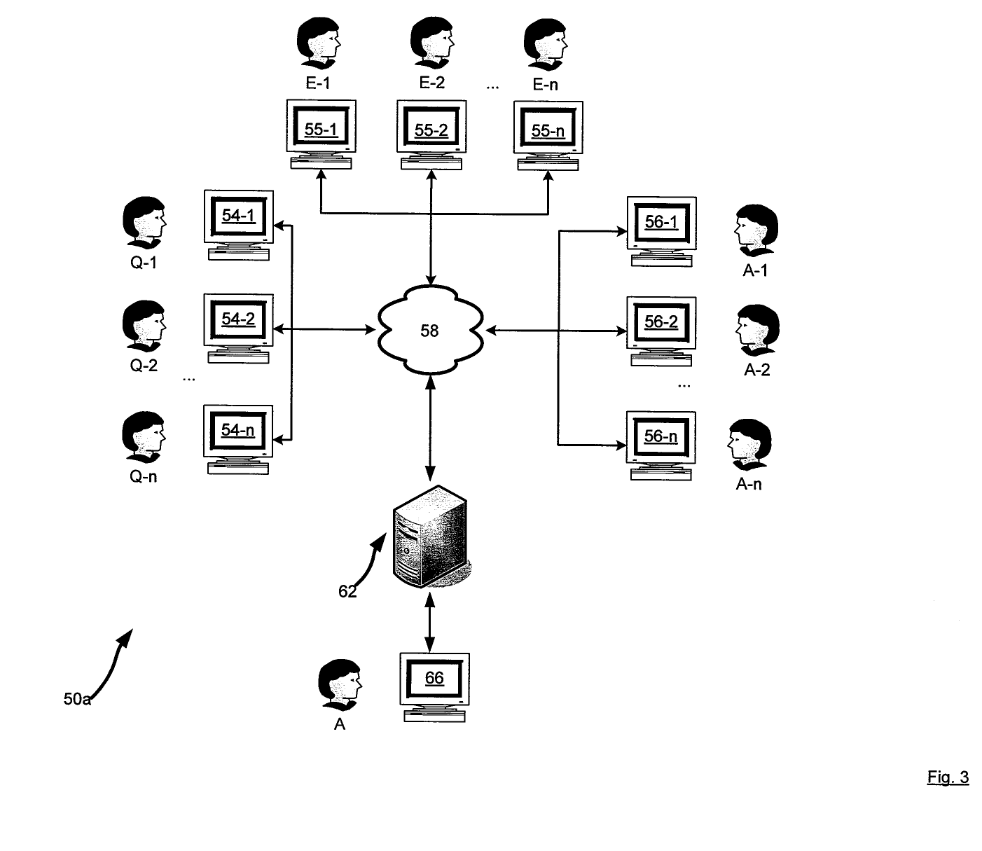

Referring now to FIG. 3, a variation of system 50 is shown and is indicated generally at 50a. System 50a includes all of the same components as system 50, but also includes a plurality of additional workstations 55 that are operated by third-parties referred to herein as enhancers E. Enhancers E can be any party that is permitted (according to privileges set on engine 52) to interpose itself between the interactions of questioners Q and answers A within the context of a suitably modified version of method 200. For example, an enhancer E could be a third-party that elects to provide the compensation pool at step 210. An enhancer E could also be a party that monitors a question posed at step 205 and, because of unique expertise of that enhancer E, that enhancer E can offer to assist the questioner Q with clearer and/or more precise phrasing of the question. By the same token, an enhancer E could also monitor responses submitted at step 220 and likewise offer to clarify and/or augment the substance of a particular response provided at step 220. Depending on the involvement of a particular enhancer E, it can be desired to permit that enhancer E to participate in the division of the compensation pool at step 235 or at some other appropriate time.

While the foregoing describes certain embodiments, it should be understood that variations, subsets, enhancements and/or combinations thereof are contemplated. For example, the embodiments are presently preferred to be implemented in a computing environment, although differing computing environments and even manual environments are contemplated. As another example, it is contemplated that any answerer can suggest that a larger compensation pool be provided before an answer is provided. The system can be configured so that, in this example, the system will keep a given answer confidential until their condition of an increased compensation pool is met. However, even if the compensation pool is increased, it does not require that the questioner actually select that answer as the “best” answer, and indeed a portion of the compensation pool can still be provided to another answerer according to the selection of the questioner. The system can also be configured so that the answerer can provide some of their answers and retain some other of their answers until their condition is met, analogous to an auction.

As another example, the NLE can be configured to decipher questions and compare to previously-asked questioner so a future question such as “When was Richard Nixon born?” will be treated equivalently to “What is Richard Nixon's birthday?”. The system can then suggest to the questioner such possible equivalent questions that have been previously answered and which can be chosen by the questioner. If the questioner selects such an equivalent question, and accepts the answer provided therewith, then a larger portion of the compensation pool relative to that question can be transferred back to the questioner.

As another example, it should be understood that the size and/or allocation methodology of compensation pool referred to at steps 210 and 235 is not particularly limited. For example, a questioner may also choose to have an agent who agrees to filter the answers, especially in the case where a large number of answers have been provided and the questioner does not want to nor have the time to go through all the answers. Such an agent can be helpful in simplifying tasks for the questioner. Thus, a portion of the compensation pool, perhaps the entire portion designated for the questioner, can be provided to the agent. As another example, compensation to the operator of engine 62 can be set to a percentage (e.g. five percent) of any portion of the compensation pool that is designated for the questioner, which is only provided to the operator of engine 62 in the event that the questioner elects to “cash-out”, thereby creating an incentive for questioners to stay within the system and not to “cash-out”.

As another example, the compensation pool can be configured to reflect “credits” that can be extremely relevant to those who hold such credits, as, for example, the system can be configured so that answerers that hold higher amounts credits can have a greater chance of being selected when answering but also has more power rating others.

In general, the present specification provides an engine that provides a tool for Questioners Q to input questions, (and/or information requests and/or problems and/or the like) and compensates Answerers A who supply the best (or otherwise desirable) answer (and/or information and/or solution and/or the like) with money or other consideration. In some cases award the Questioners, and Answerers and other parties may also be compensated. For example, extra compensation may be provided to top performers in a given month and/or in a given category as sponsored by a given third party company.

The engine can be configurable to evolve to become capable of answering, or at least soliciting answers to, any question asked by anyone. Questions can be text messages from phones, submitted through the Internet, emailed, or simply phoned to a voice mail server.

The system, in different configurations, permits participation of a plurality of different entities. The first entity is the questioners. The system provides a simple user interface for questioners on a network such as the Internet for questioners to browse. In one embodiment, by simply inputting a question in natural language. The questioners can be given the choice of the designating the answerers A for a question, or the questions can simply be sent to answerers without input from the questioners. The questioners may, in some embodiments, also designate a level of compensation which forms a compensation pool from which various participants in the system can be compensated upon receipt of a satisfactory answer.

The Questioners may also choose to input their questions by using text messaging from their cell phones, faxing, or calling the central telephone line and leaving a voice message or simply emailing the data exchange engine.

The second entity is the answerers. The system provides a graphic interface for the public to login using any desired means of authentication, such as by simply putting their trusted email address or logging in (UserId or NickName and password) and then browsing the most recently asked questions and answered publicly by searching those questions and sorting them by any relevance or category. The searched listing will also reveal the compensation amount that will be forwarded to the one supplying the best answer according to the questioner. The nonpublic questions will only be viewed/accessed by dedicated entity(s) which are categorized and identified by profession/organization/institution via email or prior membership into the system. Alternatively. the Answerers may choose to dial a toll free number and listen to the questions posed verbally.

Once the answer is given to the chosen question, the Answerer is prompted to optionally specify the type or category of answer provided (solution, method, answer, e.g. opinion)

The third entity is the data exchange engine. The engine can have several processors that are constantly working by analyzing inputs into the system (the questions and answers) and are trying to find the best answers by using the existing answers via an algorithm that analyzes a history of similar questions and their processed answer into the database. This can allow for substantially instant responses to these analyzed questions. This software component would be similar to existing natural language software and/or could be a licensed natural language software augmented with an additional AI component that continually becomes enhanced as the system evolves over time and acquires more data. The engine may not only be based on the questions and answers but also on the profile of each and every participant, (e.g. questioner, answerer, and enhancer).

Depending on who is asking the question, an answer would be generated accordingly. This algorithm engine and its group of processors we would refer to as the System.

The fourth entity is the Enhancers, which are in fact optional. The Enhancers can be any third party, either human or computer-based, which can act to improve the dialogue between the questioners and the answers. The data exchange engine can provide a graphical interface and programming interfaces to allow software developers, mathematicians, gurus, professionals, field experts and/or other parties who are capable of designing or enhancing internal processes. The enhancers can access any question or answer that is present within the engine. One expected scenario is for the enhancers to examine answers that were not satisfactory to the questioners. The enhancers typically will have an account maintained by the engine. Once logged in, enhancers can be given read only access to all question and answer data along with the ratings which are not accessible by all of the questioners and the answers, and by having this access, they can offer the answerers the ability to have their own answers improved using the services of the enhancers.

In one embodiment, if an answer that is enhanced (or produced by the enhancers systems or people) is chosen by the questioner, then 80% of the funds compensation pool are sent back to the questioner, and the enhancer that enhanced the answer will obtain 20%, or split the remaining 20% with the original owner of the answer or the operator of the engine. This profit will motivate this group's effort to have Questioners immediately choose their answers as much as possible. Again, the exact apportionment can be adjusted as desired.

Enhancers can also include refiners. Refiners can also refine the questions and answers provided by others (either electronically or manually) and the refined data will be stored in database records separate from the database records stored on the main engine until validated by questioners and answerers.

Enhancers can also include forecasters. Forecasters can have subgroups of people populating and/or filtering population of question and answer data that can be provided by anyone from the public. (For example any person can enter the question/request and the answer/solution in the hope that someone will have the same question one day so the answer can be displayed immediately, they can also specify the minimum amount for that answer to be revealed)

Enhancers can also include agents. Agents can provide answers/solutions filtering services, to the Questioners for an agreed fee could be the 20% of the initial amount to be forwarded to the agents and/or additional amount that can be agreed on (i.e. out or 100 answers they can filter them down to 10 so the Questioner can choose his/hers easily) that service can be done by splitting the portion of the compensation pool that is provided to the Questioner once the final selection has been determined and the question is closed. However the Questioners can always choose to filter the answers using various sorting i.e. sorting the data by the top performers (high rating) and/or by the rated answers by answerers ARA

Enhancers can be independent companies or individuals who have found interest in competing with other companies or individuals offering the same service. Initially, the system can offer opportunity equally to all the enhancers, but as an enhancer's ratings change overtime, those enhancer's with a higher rating can be ranked more highly. As enhancers merge, then they can share strategies, algorithms and possibly merge.

The implementation of the compensation pool is not particularly limited. In one example, the monetary value of an answer can have a minimum of $3 up to an unlimited amount. Initially, amounts that are less than $10,000 are cleared immediately. The operator of the engine/the system company can charges 5% or $2 whichever is greater per question entered as a service/transaction fee, or the operator of the engine can charge nothing and rely on advertising revenue. The Questioner can have the option to invest, in the compensation pool, a minimum amount of, for example, $5. Once having invested in the first question, the returned amount from having selected an answer can be set at 20% of the original investment. The returned amount can be re-invested into any question for any amount, without having the restriction of a $3 minimum charge. Similarly the money gained from answering a question can always be reinvested into questions at anytime. When the amount in an account total is a fraction of one cent, the amount is rounded down.

The Questioner may at any time decide which the best answer to the question is directly, or through an agent. Once the best answer is selected, 80% of the compensation pool would be forwarded to the Answerer that owns the best answer. The 20% of the amount would be forwarded to the Questioner's account. Once the best answer has been chosen. All of the rest of the answerers are notified immediately if they so choose. The question can, after compensation is closed by the questioner, if desired, remain open in the system for anyone with high ranking (high varies with time) to respond, as Answerers may be motivated to continue providing responses to increase their chances of getting selected in the future

The engine will keep a record of all interactions conducted via the engine. Once the best answer is identified, the engine can be configured to assign a rating for the answering user. The user of the selected answer may, in this case, not only receive the monetary amount from having been selected, but will also receive points awarded towards his or her rating (higher ranking), such a rating indicating the reliability and/or quality of that particular answerer. Rating points can add to the person's profile, and an answerer certification program may also be implemented, which may help academics and professionals get jobs or get promoted based on skills witnessed through the system and could possibly obtain references from the questioners who could possess some social/political/professional status.

If no answer is selected, the compensation pool can remain in control of the operator of the system, hence (see 0072) to be dedicated to this question until the question is answered, unless the questioner decides to cancel the question, in which case the questioner may only be eligible to claim back a portion of a compensation pool provided by the questioner—such an amount would typically be low, say 10%, in order to encourage the questioner to actually obtain 20% by actually selecting an answer.

If the questioner does not select a best answer, then the questioner can be notified and if by the end of a predefined time period an answer has not been chosen then the question can be closed to new Answerers, and the decision to be made regarding the “best answer” is made by a rating process conducted by the answerers. The owner of the highest rated answer will get to retain 80% of the compensation pool.

If no one answers a question, the system can be configured to allow the questioner to revise and pose again the same question for the same amount to be awarded.

The questioner may at any time decide to increase the amount of the compensation pool to create a greater incentive to acquire a better answer and is also an indicator for those who already answered that the question is still outstanding and that their answers were not satisfactory.

The system can be configured to allow the answerers to provide only one answer per question per person. If some answerers use different emails to increase the chances of having the best answer chosen, they can have their privileges revoked by for breaching a system agreement. If the answerer wishes to provide more than one answer to a question, then the system can be configured to permit multiple answers as part of the same Solution which can have many answers. The Answerer can also be permitted to request a discussion with the Questioner.

If a question submitted by a questioner already exists in the database history then any compensation pool monetary amount can be added to the previous amount(s) as the maximum possible reward for the chosen answer given that the answer is chosen by all the questioners of the existing question. Otherwise the amounts will be split accordingly.

If some of the answers for the same questions were chosen by some questioners, while still some other questioners have not selected an answer question can remain partially open while revealing all the answers to the questioner.

Answers to questions that have been previously provided answered and stored in the system database can be made available to the Questioners for only 20% of any compensation pool offered by the questioner, and then 80% of the compensation pool would be returned to the questioner's account.

The system can evolve by developing artificial intelligence that can answer automatically based on previously collected data. Such artificial intelligence can be provided by algorithms provided by the operator of the engine and/or by enhancers.

Some questions may require the answerers to research the Internet. In such cases, hyperlinks to websites and other content found during that research and reference can be attached to provide answers as evidence and support, which can increases the chances that their answer gets selected by the questioner as the best answer. The system can provides a tool/interface for users which enhances their browser while searching the internet, by having a sub-browser within the user interface and a rich-text box that allows users to start composing their response while browsing the Internet on the same page and, optionally, having the engine track their browsing history while the answerer selects which browsed content is to be included in their response.

Once the best answer is chosen by the Questioner, the funds from the compensation pool would typically be transferred to the answerers after 24 hours, unless the following exception occurs: If all the provided Answers are made public to all the answerers, and are sorted by default in chronological order, and if the chosen answer previously existed but was missed or was not chosen by the Questioner, then the owner of that answer may dispute the provision of the funds from the compensation pool to the other answerer and within this 24 hour period, amounts would be held for a during a dispute resolution process. As a result of the dispute resolution process, the amount will be transferred to the actual owner of the answer.

In the event that the questioner chose an answer that is believed to be inferior by another answerer, then that answerer may notify the questioner (unless the questioner has set a profile that does not accept such notifications) requesting that the questioner reconsider the selected answer. Although the rating and compensation funds has already been effected, the Questioner can then at least decide to re-rate the best answer as having the best rating instead and thereby improve the ratings for a particular answerer, so that the answerer can have a better chance in gaining favor with other questioners in the future.

Answerers may choose their answers to be public or private, and private answers will not be available for any user after the question is closed, but could be configured so that private answers are available for the enhancers and the administrator ADMIN, and in this way an answerer can have his/her answer displayed to the questioner and if selected, the answerer will collect part of the 10% of the amount in the pool associated with that question. In other words, if a user is browsing questions and happens to see a question that has one or more private answers, the user can either pay a specified amount to see the answers each at a time, or put that same question in the system with the minimum amount that allow him/her to see all the answers along with the one chosen by the previous questioner. Browsing users can simply choose the chosen answer by previous questioner. The public answers are available for anyone who logs into the system to see while browsing, searching or questioning for free. Hence the system can allow the users choose to use and exchange information for free or for a fee.

There can be various types of graded ratings for the Answerers. one type of graded rating for the Questioners and one type of flagging for everyone. The first type of rating system has the acronym QRA (Questioner Rating Answerer). This rating of the answers is to be optional with possible values of, for example, 1 to 9 out 10, however by default every chosen “best” answer will automatically give its owner a rating of 10 out of 10. As the Questioner is browsing through the answers, the questioner can rate the answers by selecting a value from 1 to 9, which will be stored in the answerer's profile and can be changed by the Questioner through the life of the opened question or while the question remains opened.

In certain embodiments, every answer provided can be rated but only one answer will receive a 10/10 score, and the share of the compensation pool amount awarded for that question.

Another type of rating system has the acronym (ARA) (Answerers or Anyone Rating Answerers). In this case other Answerers or Enhancers or anyone with an account logged into the system and has the capability to view that answer i.e. it's made public will read the answers and rate those answers as desired. One possible rating system is an “A-F” system, with A being the best. D being the worst. and F being either not applicable or wrong.

Another third type of rating has the acronym (ARQ) (Answerers Rating Questioners) and this can be done at one or more possible stages. The average of the rating can be displayed, unless only one stage has been effected. ARQ ratings can be based on the clarity of the question asked, which can help the answerers and the enhances to categorize the questioner for the future. The first stage of rating can be before the answer is chosen. a second stage can be after the answer is chosen.

It can also be desired to add the feature of permitting anyone from any group to flag anyone. If the flagger has flagged repeatedly wrongfully, they can be dismissed of the system. Similarly the flagged person happens to be flagged correctly then this flagged person can be dismissed out of the system. The repletion rate for this can initially be set to three, but may change through the evolution of the system.

Any rating can affect the rating power of the relevant party and therefore the subject being rated, so when that subject is rating, and the average of all rates can be calculated to contribute to the grade a particular individual or object. For example a highly rated individual could for example have twice more power then a less rated individual when rating another object, in that case if the first individual gives 9/10 for an object and the second individual gives 6/10 then that object will not have a final average of 7.5/10 but, it will have a final average of 8/10. Any AI component in the system can be configured to devote greater processing effort towards questions or answers originating from parties with high ratings. For example, if the AI component of the system has to choose between two equal solutions or data, it will choose the one coming from the individual with higher rating.

In one embodiment, a new user to the system can be set to have a rating power of 100%. Initially the rating power can be increased or decreased based on the following factors, If an answer or a request is rated higher then the average, that will increase the rating power, if they are rated negatively that will decrease their rating power. The method below has sample formulas that can demonstrate how this could work while giving the illusion to the user of losing points meanwhile the lost points are always recuperated during each activity within the session. every rating given to an answer or average ratings given to a questioner will be added or subtracted from the 100 as follows:

1—Initial factors that increases the rating power:
a. Putting questions/inquiries into the system (4 Points)
b. Putting answers/responses to questions (4 Points)
c. Every question and answer's ratings the rating 5/10 will not impact the users rating. a 6/10 will give (+1) and a 9/10 will give (+4). 10/10 will always give 10 points.

2—Initial factors that decreases the rating power:
a. Every question and answer's ratings the rating 5/10 will not impact the users rating, a 1/10 will give (−4) and a 4/10 will give (−1).

3—A non rated Answer will get (−3) which will result to +1 for the requester

In one embodiment, each and every individual can have at least three major public components in their profile. Flagged users will not be shown that they are flagged to the public: a. The number of questions asked along with the question's rating (by the Answerers), the monetary amounts invested and the comments received; b. The number of answers provided along with the 2 types of ratings/grades, the monetary amounts gained and the comments received; c. their nickname or system name

If desired, any of the entities can at anytime donate money earned or simply paid as a donation to the system by financing more research and development or to other groups/individuals belonging to groups within the system, usually based on their contribution to system and data enhancements,

Users can contribute to a survey that will also be taken in consideration based on their rating power, i.e. if ten users in total contribute to a survey the first user with 100% rating power is to suggest in a survey that the interface of questions is better to the left of the screen instead of the top, and nine other users with 100% rating power were to suggest otherwise, the survey would result in the first suggestion.

If desired, the system can be configured so that the Questioners and/or the Answerers can at any time initiate a discussion. The system can be configured so that many answerers can request to join in, but only the questioner can approve or reject an answerer from joining the discussion. The main purpose of the discussion is to either elaborate on an answer or solution, or to further simplify it.

If desired, the system can be configured so that any Answerer may at anytime suggest a higher amount than the one suggested by the Questioner. If the Questioner accepts. The amount would be added into the pool of that question and not directly to that Answerer, and may be rewarded to the owner of the chosen answer, which may not necessarily be the one who suggested the raised amount. If the answerer price higher answer for higher then what the questioner priced that question, the answer will not be revealed to the questioner unless the higher amount is paid. If an answer was never revealed through a session even though a satisfactory answer was chosen, the answer will still be saved private in the system as a possible answer to that question and will only be revealed if the same question comes again with the amount requested or higher amount, in that case as mentioned above 80% of that amount will be sent back to the questioner and the remaining will be shared by the answerer and the system.

If desired, the system can be configured so that questioners can have the option to ask a question without contributing to the compensation pool, in exchange for agreeing to possibly have advertisements displayed to the questioner and answerer on, for example, either or both of the circumference left and right of the screen without impacting the functionality in the centre. In this case the funds for the compensation pool would be raised by third party sponsors through the operator of the engine. The value of the compensation pool could be a variable amount (x) that fluctuates based on the market, where (x) is the amount the sponsors pay into the compensation pool for that question for every rated answer for a total (n). The value could be based on keywords, topics, concept, subject or the like. Sponsors can thus configure their profile prior to or after a question has been posed. As an example, assume an automobile manufacturer wishes to sponsor a compensation pool and to establish a profile before a question is posed. In this example, the automobile manufacturer many indicate that they will contribute to any compensation pool in the amount of 1× where there is question includes the word “car”, and likewise that the automobile manufacturer will contribute an amount of 10× where the question includes reference to a model of car manufactured by that automobile manufacturer.

1. A system for exchange of data comprising:
a plurality of questioner workstations connectable to a network;
a plurality of answerer workstations connectable to said network;
a data exchange engine connected to said questioner workstations and said answerer workstations via said network; said data exchange engine configured to receive at least one question from at least one of said questioner workstations and to present said at least one question to at least one of said answerer workstations; said data exchange engine further configured to maintain a compensation pool associated with said question; said data exchange engine further configured to collect answers to said question and present said answers to said questioner; said data exchange engine further configured to distribute at least a portion of said compensation pool to an answerer associated with at least one of said answerer workstations; said data exchange engine further configured to receive a quality rating for each of said answers; said compensation pool being distributed to said answerer based on said answerer according to said ranking quality.

2. The system of claim 1 wherein said compensation pool is provided by a questioner associated with the one of said questioner workstations that provided said at least one question.

3. The system of claim 1 wherein said compensation pool is provided by a sponsor.

4. The system of claim 1 wherein said quality rating includes receiving an indication from said questioner as to which of said answers is the best answer.

5. The system of claim 1 wherein a portion of said compensation pool is distributed to said questioner upon completion of said quality ratings for each of said answers.

6. The system of claim 1 wherein said quality rating is provided by said answerers.

7. The system of claim 6 wherein said quality rating is only provided by said answers if said questioner does not provide said quality rating.

8. The system of claim 6 further comprising a plurality of enhancer workstations connected to said engine via said network; said enhancer workstations configured to present either said questions or said answers and to receive data representing an improvement to said questions or said answers.

9. The system of claim 1 wherein said workstations are comprised of one or more of a computer, a wireless personal digital assistant, a cellular telephone, a telephone and a facsimile machine.

10. A computer-based method of exchanging data comprising:
receiving a question from a questioner from a questioner workstation at an data exchange engine;
defining at said data exchange engine a compensation pool for said question;
presenting said question to at least one answerer workstation operated by answerers;
receiving responses to said question from said answers;
distributing said compensation pool amongst one or more of said answerers and said questioners based on a rating for at least one of said answers.

11. The method of claim 10 wherein said rating is received from said questioner.

12. The method of claim 11 wherein said rating indicates the subject view of said questioner as to which of said answers was the best answer.

13. The method of claim 11 wherein a portion of said compensation pool is distributed to said answerer having provided said best answer.

14. The method of claim 10 wherein said rating is received from a plurality of said answerers.

15. The method of claim 14 wherein said rating is received from said plurality of said answers if said questioner declines to provide said rating.

16. The method of claim 10 wherein said compensation pool is provided by said questioner.

17. The method of claim 10 wherein said compensation pool is provided by a sponsor.

18. The method of claim 10 wherein a portion of said compensation pool is distributed to said questioner upon completion of said quality ratings for each of said answers.

19. The method of claim 10 further comprising the step of receiving enhancement data from one of a plurality of enhancer workstations connected to said engine; said enhancement data representing an improvement to said questions or said answers.

20. The method of claim 10 wherein said workstations are comprised of one or more of a computer, a wireless personal digital assistant, a cellular telephone, a telephone and a facsimile machine.

21. A data exchange engine in a system for exchange of data having a plurality of questioner workstations connectable to a network; and a plurality of answerer workstations connectable to said network; said data exchange engine comprising:
a network interface for connecting to said questioner workstations and said answerer workstations via said network;
at least one processing unit connected to said network interface and configured to receive at least one question from at least one of said questioner workstations and to present said at least one question to at least one of said answerer workstations; said processing unit further configured to maintain a compensation pool associated with said question; said processing unit further configured to collect answers to said question and present said answers to said questioner; said processing unit further configured to distribute at least a portion of said compensation pool to an answerer associated with at least one of said answerer workstations; said processing unit further configured to receive a quality rating for each of said answers; said compensation pool being distributed to said answerer based on said answerer according to said ranking quality.
